(19) United States
(12) Patent Application Publication
(10) Pub. No.: US 2026/0290298 A1
(43) Pub. Date: Sep. 24, 2026

(54) LAMINATED ACOUSTIC BAFFLES AND METHODS OF MANUFACTURING LAMINATED ACOUSTIC BAFFLES

(71) Applicant: The Soundcoat Company, Inc., Deer Park, NY (US)

(72) Inventors: Thomas Burns, Centerport, NY (US); Digno Esau Iglesias, Islip Terrace, NY (US)

(21) Appl. No.: 19/573,354

(22) Filed: Mar. 20, 2026

Related U.S. Application Data
(60) Provisional application No. 63/774,830, filed on Mar. 20, 2025.

(51) Int. Cl. G10K 11/168; F16B 5/00

(52) U.S. Cl. CPC G10K 11/168; F16B 5/002

(57) ABSTRACT

A laminated acoustic baffle includes first and second panels, a support structure, and first and second facings. Each of the first panel and the second panel define respective opposing front and back surfaces, each extending between opposing top and bottom surfaces and opposing first and second end portions. The support structure is interposed between the bottom surface of the first panel and the top surface of the second panel. The first facing is operably coupled to the front surfaces of the first and second panels. The second facing is operably coupled to the back surfaces of the first and second panels. Each of a first end portion and an opposite, second end portion of the support structure is exposed through each of the first and second panels and the first and second facings.

### SUMMARY

This application claims the benefit of, and priority to, U.S. Provisional Patent Application No. 63/774,830, filed on Mar. 20, 2025, the entire content of which is hereby incorporated by reference herein.

### BACKGROUND

### Technical Field

The present disclosure relates to the field of noise suppression, and in particular, laminated acoustic baffles for suppressing noise within an environment.

### Description of Related Art

Acoustic baffles may be used to mitigate, deflect, or otherwise channel sound within an environment. These acoustic baffles are often formed from lightweight, low-density, and low-strength materials to reduce a load imparted on a ceiling or other structure supporting the acoustic baffles. As can be appreciated, these materials may be prone to damage or may need additional material to enable the acoustic baffles to be suspended and/or attached to the ceiling and/or structure. Additionally, these lightweight materials may not provide adequate stiffness and strength to support themselves or additional acoustic baffles that may form a grid or other pattern for mitigating noise within the environment. Such acoustic baffles may not be easily attached or coupled to other acoustic baffles, either inhibiting the coupling of adjacent acoustic baffles to one another or necessitating additional hardware, increasing the cost of the acoustic baffle systems and the time needed for installation.

### SUMMARY

One aspect of the disclosure is directed to a laminated acoustic baffle including a first panel defining a front surface and an opposite, back surface, each extending between opposing top and bottom surfaces and opposing first and second end portions, a second panel defining a front surface and an opposite, back surface, each extending between opposing top and bottom surfaces and opposing first and second end portions, and a support structure interposed between the bottom surface of the first panel and the top surface of the second panel. The support structure extends between a first end portion and an opposite, second end portion. The laminated acoustic baffle also includes a first facing operably coupled to each of the front surface of the first panel and the front surface of the second panel, and a second facing operably coupled to each of the back surface of the first panel and the back surface of the second panel. Each of the first end portion and the second end portion of the support structure is exposed from each of the first panel, the second panel, the first facing, and the second facing.

Another aspect of the disclosure is directed to an acoustic baffle assembly including at least two laminated acoustic baffles. A first laminated acoustic baffle of the at least two laminated acoustic baffles is selectively interlockable with a second laminated acoustic baffle of the at least two laminated acoustic baffles. Each of the first laminated acoustic baffle and the second laminated acoustic baffle includes a first panel, a second panel, a support structure interposed between the first panel and the second panel and extending between a first end portion and an opposite, second end portion, a first facing operably coupled to a first side of each of the first panel and the second panel, and a second facing operably coupled to a second, opposite side of each of the first panel and the second panel. Each of the first end portion and the second end portion of the support structure is exposed from each of the first panel, the second panel, the first facing, and the second facing.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

Various aspects and embodiments of the disclosure are described hereinbelow with references to the drawings, wherein:

FIG. 1 is a perspective view of a laminated acoustic baffle in accordance with the disclosure;

FIG. 2 is a front, elevation view of the laminated acoustic baffle of FIG. 1;

FIG. 3 is a side, elevation view of the laminated acoustic baffle of FIG. 1;

FIG. 4 is an exploded perspective view of the laminated acoustic baffle of FIG. 1;

FIG. 5 is an exploded, front elevation view of the laminated acoustic baffle of FIG. 1;

FIG. 6 is a partially exploded, side elevation view of the laminated acoustic baffle of FIG. 1;

FIG. 7 is a partially exploded, side elevation view of laminated acoustic baffle of FIG. 1, illustrating opposing facings couplable to front and back faces of the laminated acoustic baffle;

FIG. 8A is an enlarged view of the area of detail indicated in FIG. 3;

FIG. 8B is an enlarged view of another embodiment of the area of detail indicated in FIG. 3;

FIG. 9 is a perspective view of the laminated acoustic baffle of FIG. 1, shown with a support coupling coupled to a support structure of the laminated acoustic baffle;

FIG. 10 is a perspective view of another embodiment of a support structure of the laminated acoustic baffle of FIG. 1 in accordance with the disclosure;

FIG. 11 is a side, elevation view of another embodiment of a laminated acoustic baffle including the support structure of FIG. 10;

FIG. 12 is a perspective view of the laminated acoustic baffle of FIG. 11 illustrating a support coupling coupled to the support structure of FIG. 10;

FIG. 13 is a perspective view of the acoustic baffle assembly of FIG. 11 illustrating a first acoustic baffle coupled to an adjacent second acoustic baffle using a joint coupling that is coupled to the support structure of each of the first acoustic baffle and the second acoustic baffle;

FIG. 14 is a perspective view of another embodiment of the laminated acoustic baffle of FIG. 12, shown with a planar end portion;

FIG. 15 is a perspective view of an acoustic baffle assembly in accordance with the disclosure;

FIG. 16 is an exploded perspective view of the acoustic baffle assembly of FIG. 15;

FIG. 17 is a perspective view of a first laminated acoustic baffle of the acoustic baffle assembly of FIG. 15;

FIG. 18 is a front, elevation view of the first laminated acoustic baffle of FIG. 17;

FIG. 19 is a side, elevation view of the first laminated acoustic baffle of FIG. 17;

FIG. 20 is a perspective view of a second laminated acoustic baffle of the acoustic baffle assembly of FIG. 15;

FIG. 21 is a front, elevation view of the second laminated acoustic baffle of FIG. 20;

FIG. 22 is a side, elevation view of the second laminated acoustic baffle of FIG. 20;

FIG. 23 is a perspective view of a third laminated acoustic baffle of the acoustic baffle assembly of FIG. 15;

FIG. 24 is a front, elevation view of the third laminated acoustic baffle of the acoustic baffle assembly of FIG. 15;

FIG. 25 is a side, elevation view of the third laminated acoustic baffle of FIG. 23; and

FIG. 26 is an exploded, side elevation view of the third laminated acoustic baffle of FIG. 23.

### DETAILED DESCRIPTION

The present disclosure is directed to an acoustic baffle assembly including one or more laminated acoustic baffles. At least one of the laminated acoustic baffles includes a first panel and a second panel. Each of the first panel and the second panel define a respective front surface and an opposite, back surface, each extending between opposing top and bottom surfaces and opposing first and second end portions. The at least one laminated acoustic baffle also includes a support structure interposed between the bottom surface of the first panel and the top surface of the second panel, where the support structure extends between a first end portion and an opposite, second end portion. The at least one laminated acoustic baffle also includes a first facing and a second facing. The first facing is operably coupled to each of the front surface of the first panel and the front surface of the back panel, and the second facing is operably coupled to each of the back surface of the first panel and the back surface of the second panel. Each of the first end portion and the second end portion of the support structure is exposed from each of the first panel, the second panel, the first facing, and the second facing.

The laminated acoustic baffles and acoustic baffle assemblies described herein incorporate a support structure extending at least partially along the length of the acoustic baffle. In this manner, the acoustic baffle is formed by laminating two facings onto an upper panel and a lower panel sandwiching the support structure. The support structure increases the bending stiffness of the laminated acoustic baffle, increases resistance to torsion, and provides a resilient anchoring point for supporting the laminated acoustic baffle, and an acoustic baffle assembly formed of two or more laminated acoustic baffles, compared to acoustic baffles without a support structure.

Additionally, the support structures incorporated into the laminated acoustic baffles and acoustic baffle assemblies described herein include modular end portions enabling the use of various hanging, suspending, fixing, and/or joining methods (e.g., couple another laminated acoustic baffle to the first or second end portion and increase an overall length of the acoustic baffle assembly). In this manner, the load and/or forces imparted to the laminated acoustic baffle are taken by the support structure, rather than the materials forming the first and second panels.

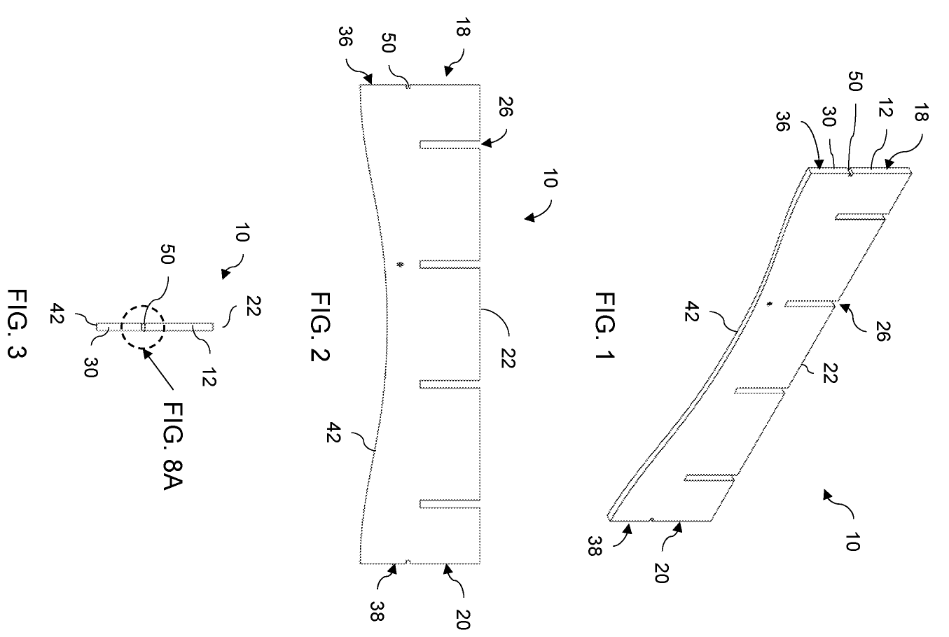

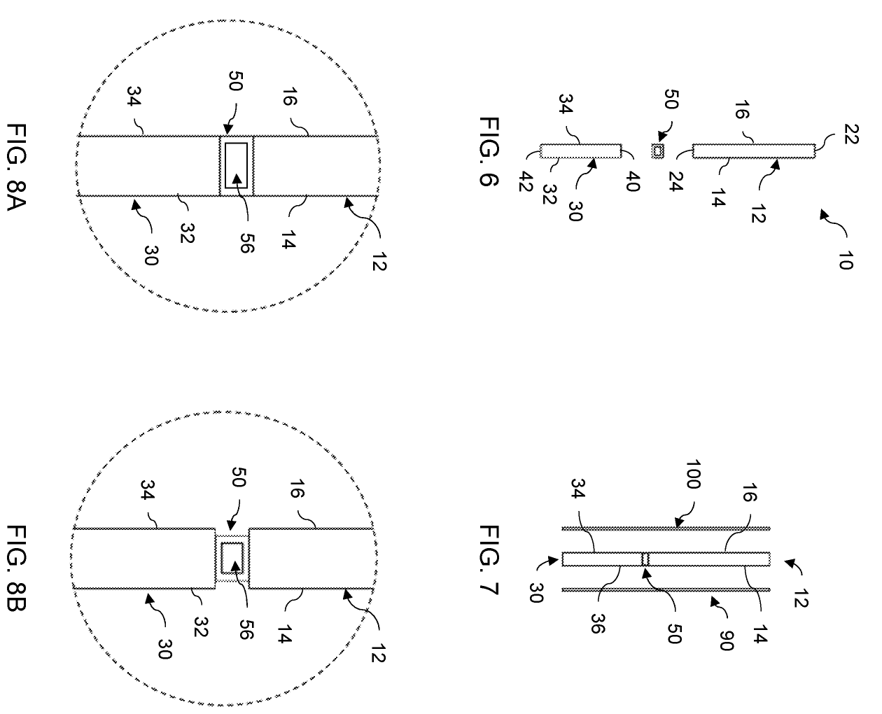

Referring now to the drawings, FIGS. 1 - 8B illustrate a laminated acoustic baffle in accordance with the disclosure, generally identified by reference numeral 10.The laminated acoustic baffle 10 includes a first panel 12, a second panel 30, a support structure 50, a first facing 90, and a second facing 100. The first panel 12 defines a generally rectangular profile, defining a front surface 14 and an opposite back surface 16 (shown in FIG. 6), each extending between a first end portion 18 and an opposite second end portion 20, and a top surface 22 and an opposing bottom surface 24. Although generally illustrated as having a rectangular profile, it is envisioned that the first panel 12 may have any profile without departing from the scope of the disclosure, such as square, oval, racetrack, circular, hexagonal, etc. and may define the same or different profile than the assembled laminated acoustic baffle 10. In one non-limiting embodiment, the bottom surface 24 of the first panel 12 defines a planar surface, although the bottom surface 24 of the first panel 12 may define any suitable profile that enables the first panel to function as described herein.

One or more slots 26 is defined through each of the front surface 14 and the back surface 16 and extending through the top surface 22 of the first panel 12. The one or more slots 26 are configured to receive and retain a portion of another acoustic baffle or laminated acoustic baffle of the acoustic baffle assembly (shown in FIGS. 14 and 15), as will be described in further detail hereinbelow. Although generally illustrated as having four slots 26, it is contemplated that the first panel 12 may include any suitable number of slots 26 depending upon the design needs of the laminated acoustic baffle 10. For example, the first panel 12 may include a number of slots 26 equal to a number of laminated acoustic baffles that are coupled to the laminated acoustic baffle 10. The first panel 12 is formed from any material or combinations of materials suitable for attenuating and/or absorbing sound. In one non-limiting embodiment, the first panel 12 may be formed from an acoustic quality foam, such as Soundfoam ML G+ manufactured and sold by The Soundcoat Company Inc.

The second panel 30 defines a profile that is generally similar to the profile of the first panel 12, although it is contemplated that the second panel 30 may define any suitable profile without departing from the scope of the disclosure. The second panel 30 defines a front surface 32 and an opposite, back surface 34 (shown in FIG. 6), each extending between a first end portion 36 and an opposing second end portion 38 and a top surface 40 and an opposing bottom surface 42. Although generally illustrated as having a dimension extending between the top and bottom surfaces 40, 42 that is less than the dimension extending between the top and bottom surfaces 22, 24 of the first panel 12, it is envisioned that the dimension extending between the top and bottom surfaces 40, 42 of the second panel 30 may be larger than or equal to the dimension extending between the top and bottom surfaces 22, 24 of the first panel 12. In one non-limiting embodiment, the top surface 40 of the second panel 30 defines a planar surface, although the top surface 40 of the second panel 30 may define any suitable profile that enables the second panel to function as described herein. It is contemplated that the second panel 30 may be formed from the same or different material as the first panel 12 depending upon the design needs of the laminated acoustic baffle 10.

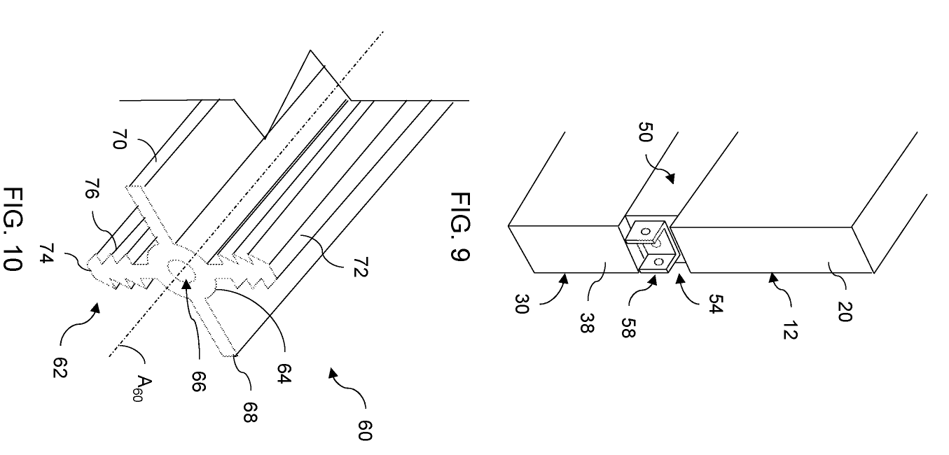

With reference to FIGS. 4-8B, the support structure 50 defines an elongate rectangular profile extending between a first end portion 52 and an opposite, second end portion 54. In the example embodiment, the support structure includes a width that is generally equal to a width extending between the front surface 14, 32 and back surfaces 16, 34 of the first and second panels 12, 30 (shown in FIGS. 7 and 8A), although it is contemplated that the support structure 50 may include a width that is less than a width extending between the front surface 14, 32 and the back surfaces 16, 34 of the first and/or second panels 12, 30 (e.g., set back or otherwise offset from the front surfaces 14, 32 and/or back surfaces 16, 34) (shown in FIG. 8B). In one non-limiting embodiment, the support structure 50 defines a tubular, rectangular profile having a hollow interior cavity extending through each of the first end portion 52 and the second end portion 54. Although generally illustrated and described as having a rectangular profile, it is envisioned that the support structure 50 may include any profile, such as circular, square, oval, racetrack, hexagonal, etc., and the bottom surface 24 of the first panel 12 and the top surface 40 of the second panel 30 may include a profile that is complimentary to the profile of the support structure 50. In some embodiments, the profile of one or both of the bottom surface 24 of the first panel 12 and the top surface 40 of the second panel 30 may intermittently or partially conform to the profile of the support structure 50. In the example embodiment, the support structure 50 is formed from a material that includes a stiffness that is greater than a stiffness of the first panel 12 and the second panel 30. In this manner, the support structure 50 increases the bending stiffness of the laminated acoustic baffle 10, increases resistance to torsion, and provides a resilient anchoring point for supporting the laminated acoustic baffle 10 and/or an acoustic baffle assembly formed of two or more laminated acoustic baffles 10, compared to an acoustic baffle without a support structure. It is contemplated that the support structure 50 may be formed from any suitable material, such as a metallic material, a non-metallic material, a composite, etc., and combinations thereof. Although generally illustrated as having a length (e.g., a dimension extending between the first and second end portions 52, 54 of the support structure 50) that is less than a length of the first and/or second panels 12, 30 (e.g., a dimension extending between respective first end portions 18, 36 and second end portions 20, 38 of the first and second panels 12, 30), it is envisioned that the support structure 50 may include any suitable length, and in embodiments, may have a length that is equal to the length of the first and second panels 12, 30 (e.g., flush with each of the first end portions 18, 36 and the second end portions 20, 38 of the first and second panels 12, 30), may have a length that is shorter than the length of the first and second panels 12, 30 adjacent only one of the first end portion 18, 36 or the second end portion 20, 38 of the first and second panels 12, 30, and/or have a length that extends past one or both of the first end portions 18, 36 and the second end portions 20, 38 of the first and second panels 12, 30.

With continued reference to FIG. 8A and with additional reference to FIG. 9, the support structure 50 includes a hollow cavity 56 extending through one or both of the first end portion 52 and the second end portion 54. Although generally illustrated as having a rectangular shape that is generally complementary to the outer profile of the support structure 50, the hollow cavity 56 may define any suitable shape that enables the laminated acoustic baffle 10 to function as described herein. The support structure 50 includes modular end portions enabling the use of various hanging, suspending, fixing, and/or joining methods (e.g., to couple another laminated acoustic baffle 10 to the first or second end portion 52, 54 and increase an overall length of the acoustic baffle assembly 200). In this manner, the load and/or forces imparted to the laminated acoustic baffle are taken by the support structure, rather than the materials forming the first panel 13 and/or the second panel 30. In some embodiments, the support structure 50 may be pivotally and/or rotatably supported about one or both of the first end portion 52 and the second end portion 54. In some embodiments, one or both of the first end portion 52 and the second end portion 54 may define a pivot point, enabling the laminated acoustic baffle 10 and/or the acoustic baffle assembly 200, to rotate about a longitudinal axis formed by the support structure 50, or in a hemispherical range of motion about the pivot point. For example, one or both of the first or second end portions 52, 54 may be rotatably and/or pivotally supported on by a support frame or by one or more tethers and/or support cables. In one non-limiting embodiment, one or both of the first or second end portions 52, 54 may be rotatably and/or pivotally supported by one or more pieces of Unistrut®, manufactured and sold by Unistrut International Corporation.

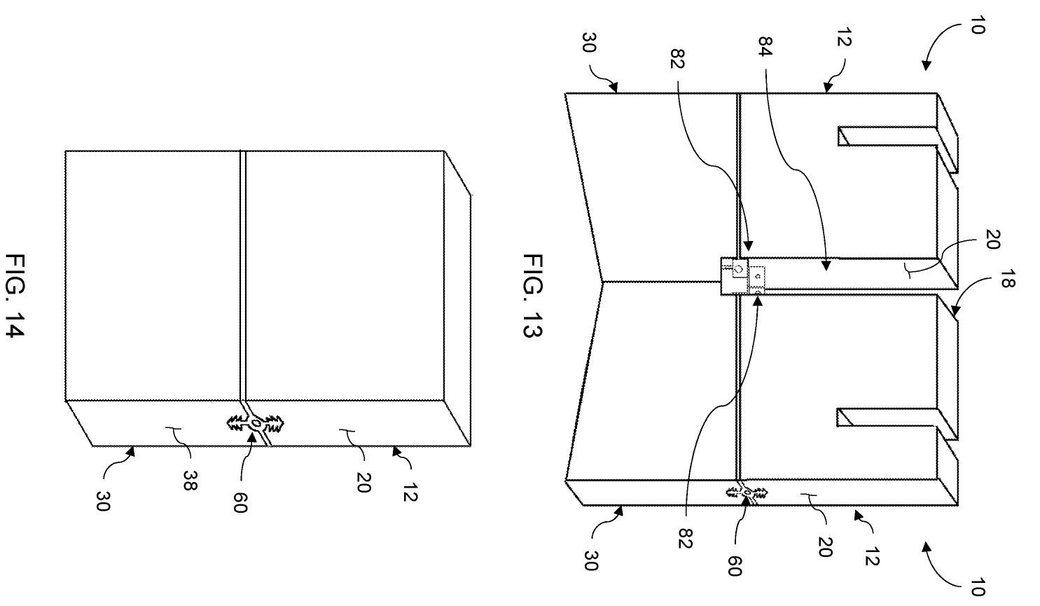

In some embodiments (shown in FIGS. 12 and 13), a notch or recess 80 is formed through each of the front surface 14, 32 and back surfaces 16, 34 and each of the first end portions 18, 36 and second end portions 20, 38 of the first panel 12 and the second panel 30, exposing the first and second end portions 52, 54 of the support structure 50. In this manner, a gap 84 is formed between the first end portions 18, 36 and second end portions 20, 38 of the first panel 12 and the second panel 30. In one non-limiting embodiment, shown in FIG. 14, the laminated acoustic baffle 10 may not include the notch 80, and rather, one or both of the first end portions 18, 36 and second end portions 20, 38 may be flush with one another and/or flush with the first and/or second end portions 52, 54 of the support structure 50.

In the example embodiment, the hollow cavity 56 may define a smooth inner surface or may define one or more features or protuberances, such as threads, ribs, etc. It is envisioned that the hollow cavity 56 may be threaded along an entire length of the support structure 50 or may be partially threaded on one or both of the first and second end portions 52, 54 of the support structure 50. The hollow cavity 56 is configured to engage or otherwise couple to one or more fasteners 58 or other suitable devices (shown in FIG. 9) for hanging, suspending, fixing, and/or joining the laminated acoustic baffles 10 and/or the acoustic baffle assembly 200 described herein (e.g., couple a second laminated acoustic baffle 10 to the first or second end portion 52, 54 of the support structure 50 and increase an overall length of the acoustic baffle assembly 200). In some embodiments, the hollow cavity 56 may include a nut, a threaded rod, etc., and combinations thereof that enable the fastener 58 to be selectively coupled to the support structure 50. In the example embodiment, the fastener 58 is a u-shaped bracket. In alternative embodiments, the fastener 58 may be an eye bolt, a threaded rod, etc. that is selectively or fixedly couplable to a support frame, a support wire, etc.

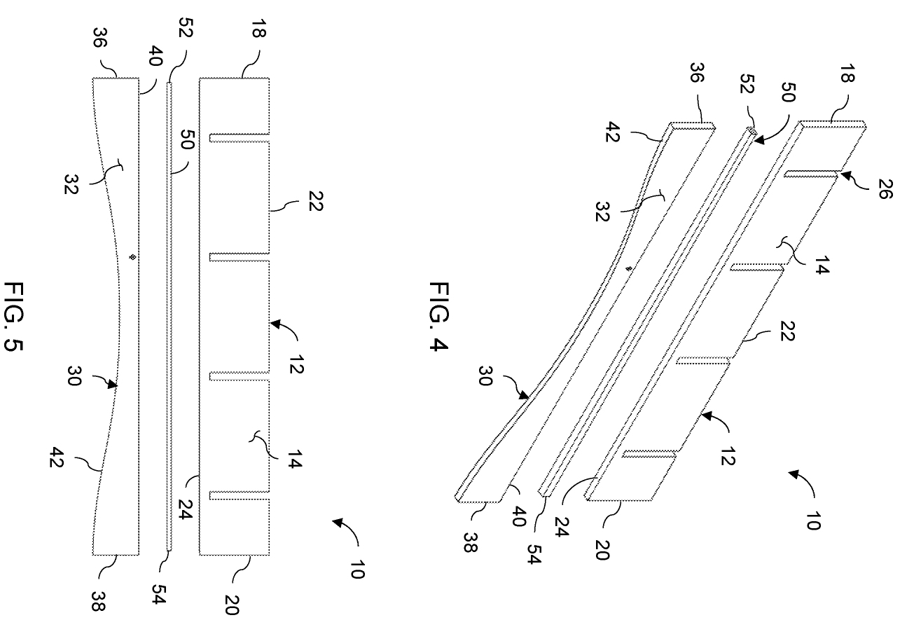

Returning to FIGS. 1-8B, the support structure 50 is interposed between each of the bottom surface 24 of the first panel 12 and the top surface 40 of the second panel 30. It is envisioned that the support structure 50 may be fixedly or releasably coupled to one or both of the bottom surface 24 of the first panel 12 and the top surface 40 of the second panel 30, and combinations thereof (e.g., fixedly coupled to the bottom surface 24 of the first panel 12 and releasably coupled to the top surface 40 of the second panel 30 and vice versa). In alternative embodiments, the support structure 50 may frictionally engage one or both of the bottom surface 24 of the first panel 12 and the top surface 40 of the second panel 30. In some embodiments, the support structure 50 may be retained between the first panel 12 and the second panel 30 by frictional engagement with one or both of a first facing 90 and a second facing 100 (FIG. 7), as will be described in further detail hereinbelow. It is contemplated that the support structure 50 may be coupled to the bottom surface 24 of the first panel 12 and the top surface 40 of the second panel 30 using any suitable means, such as adhesives, welding (e.g., friction welding, ultrasonic welding, etc.), mechanical fasteners, interlocking features, etc., and combinations thereof. Although generally described as three separate components, it is envisioned that the first and second panels 12, 30 may be combined or formed as a unitary component. In this manner, a bore (not shown) may be defined through each of the first end portion 18, 36 and the second end portion 20, 38 for receiving the support structure 50.

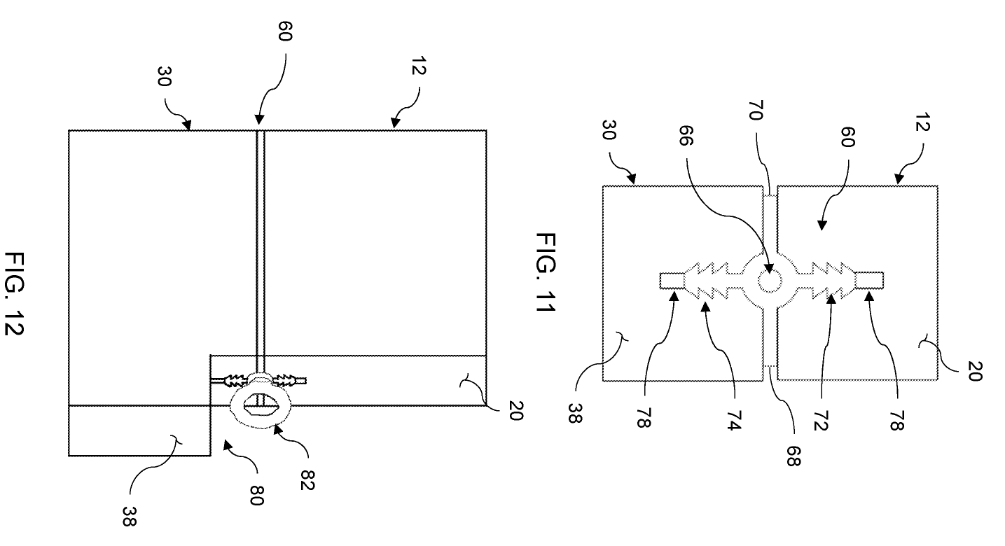

With reference to FIGS. 10-14, an alternative embodiment of a support structure configured for use with the laminated acoustic baffles described herein is illustrated and generally identified by reference numeral 60. In the example embodiment, the support structure 60 defines a generally cruciform or plus shaped profile extending along a longitudinal axis A₆₀ between a first end portion 62 and an opposite, second end portion (not labeled). A center portion 64 of the support structure 60 defines a generally circular or tubular hollow interior cavity 66 extending along the longitudinal axis A₆₀ through one or both of the first end portion 62 and the second end portion. The hollow interior cavity 66 may define a smooth inner surface or may define one or more features or protuberances, such as threads, ribs, etc. It is envisioned that the hollow interior cavity 66 may be threaded along an entire length of the support structure 60 or may be partially threaded on one or both of the first end portion 62 and the second end portions of the support structure 60. The hollow interior cavity 66 is configured to engage or otherwise couple to one or more fasteners 82 or other suitable devices (shown in FIGS. 12 and 13) for hanging, suspending, fixing, and/or joining the laminated acoustic baffles 10 and/or the acoustic baffle assembly 200 described herein (e.g., couple a second laminated acoustic baffle 10 to the first end portion 62 or the second end portion of the support structure 60 and increase an overall length of the acoustic baffle assembly 200).

In the example embodiment, a horizontal or radially extending pair of legs 68 and 70 defines a generally rectangular or planar profile configured to engage or otherwise support each of the bottom surface 24 of the first panel 12 and the top surface 40 of the second panel 30. A vertical or radially extending pair of legs 72 and 74 defines a generally Christmas tree or barbed shaped profile 76 that is configured to engage a portion of each of the first panel 12 and the second panel 30, although one or both of the pair of legs 72 and 74 may define a generally smooth surface (e.g., without barbs or protuberances) without departing from the scope of the disclosure. In one non-limiting embodiment, a slot or longitudinal cavity 78 is defined through one or both of the first and second end portions 18, 20 and 36, 38, and the bottom surface 24 of the first panel 12 and/or through one or both of the first and second end portions 18, 20 and 39, 38, and the top surface 40 of the second panel 30. In this manner, the vertical pair of legs 72, 74 is received within each slot 78 of the first panel 12 and the second panel 30 as the support structure 60 is urged in a direction extending from the second end portion 20, 38 towards the first end portion 18. 36 of each of the first panel 12 and the second panel 30 to couple the first panel 12 to the second panel 30 via the support structure 60. In some embodiments, in lieu of the vertical pair of legs 72, 74 extending along the length of the support structure 60, the vertical pair of legs 72, 74 may be defined by a plurality of discrete pins (not labeled) that are received within the slots 78 of the first panel 12 and the second panel 30 or may be received within corresponding discrete blind holes (not labeled) defined through the bottom surface 24 of the first panel 12 and the top surface 40 of the second panel 30.

Returning to FIG. 7, each of the first facing 90 and the second facing 100 is operably coupled to respective front surface 14of the first panel 12 and the front surface 32 of the second panel 30 and the back surface 16 of the first panel 12 and the back surface 34 of the second panel 30. In this manner, the first facing 90 and the second facing 100 sandwich or otherwise bookend the front surfaces 14, 32 and back surfaces 16, 34 of each of the first panel 12, the second panel 30, and the support structure 50. It is contemplated that the first facing 90 and the second facing 100 may be coupled to the first panel 12 and the second panel 30 using any suitable means, such as adhesives, welding, fasteners, mechanical features, etc. In this manner, the support structure 50 is concealed underneath each of the first facing 90 and the second facing 100. Although generally described as not being coupled to the support structure 50, it is contemplated that the first facing 90 and/or the second facing 100 may also be coupled to the support structure 50.. In embodiments where the support structure 50 is set back or otherwise offset medially inward from the front surfaces 14, 32 and back surfaces 16, 34 of the first and second panels 12, 30, the first facing 90 and the second facing 100 may not be coupled to the support structure 50. As described hereinabove, in some embodiments, the support structure 50 may fictionally engage one or more of the bottom surface 24 of the first panel 12, the top surface 40 of the second panel, the first facing 90, and the second facing 100. In this manner, the support structure is inhibited from moving relative to one or more of the first panel 12, the second panel 30, the first facing 90, and the second facing 100. In some embodiments, the support structure 50 may be inhibited from moving unless a force acting upon the support structure 50 exceeds a predetermined threshold.

Referring again to FIGS. 1-8B, a method of manufacturing and/or assembly the laminated acoustic baffle 10 includes temporarily bonding the support structure 50 to each of the bottom surface 24 of the first panel 12 and the top surface 40 of the second panel 30 to form a laminated structure. In an alternative embodiment, the support structure 50 is not bonded to the first panel 12 and/or the second panel 30. The first and second facings 90, 100 are laminated or otherwise bonded to respective front surfaces 14, 32 and back surfaces 16, 34 of the laminated structure to conceal or otherwise hide the support structure 50 under the first and second facings 90, 100. In some embodiments, the support structure is bonded to one or both of the first facing 90 and the second facing 100. In alternative embodiments, the support structure 50 is retained between each of the first panel 12, the second panel 30, the first facing 90, and the second facing 100 by frictionally engaging one or more of the first panel 12, the second panel 30, the first facing 90, and the second facing 100. The support structure 50 is utilized to index or otherwise align the laminated acoustic baffle 10 with a machining tool (not shown), such as a computer numerically controlled (CNC) cutter, to form a final profile of the laminated acoustic baffle 10, including the one or more slots 29.

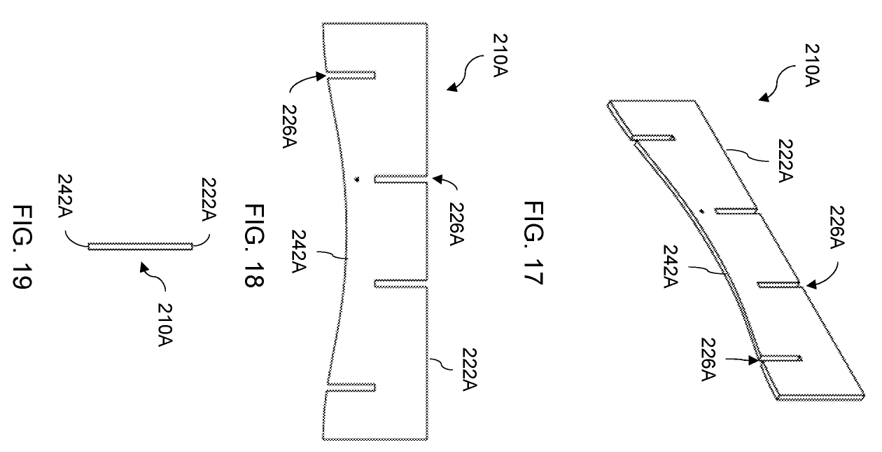

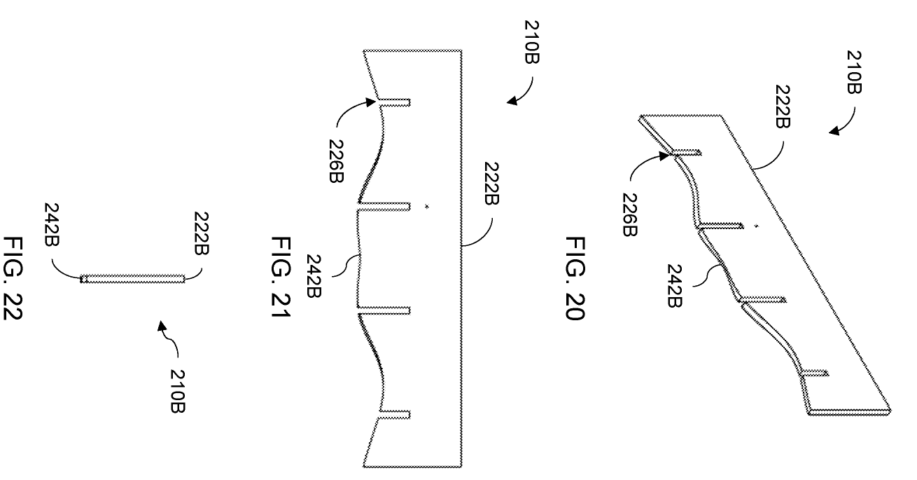

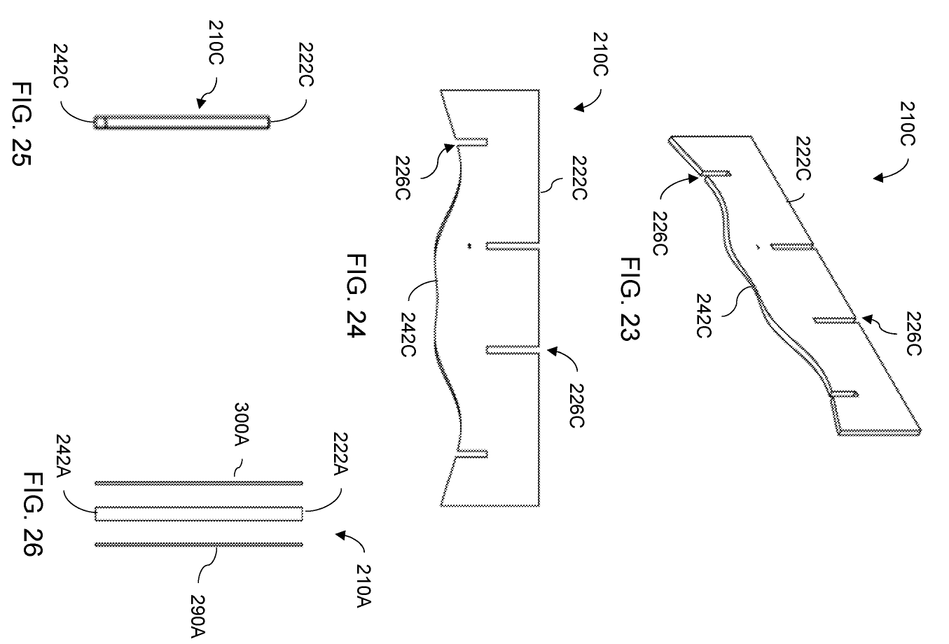

Turning to FIGS. 15-26, an acoustic baffle assembly including two or more laminated acoustic baffles is illustrated and generally identified by reference numeral 200.The acoustic baffle assembly 200 may include one or more acoustic baffles that are selectively couplable to one another and configured to be suspended from a ceiling, supported by a frame, etc. The acoustic baffle assembly 200 attenuates noise and other undesirable sounds within an environment, such as a factory, a warehouse, etc. As can be appreciated, any number of acoustic baffle assemblies 200 may be utilized in an environment depending upon the size of the environment, the type of noise and/or sounds generated within the environment, and a desired attenuation level.

In one non-limiting embodiment, the acoustic baffle assembly 200 includes eight laminated acoustic baffles selectively couplable to one another using an interlocking arrangement to form a grid, although any number of laminated acoustic baffles may be utilized and the laminated acoustic baffles may be coupled to one another using any suitable method without departing from the scope of the disclosure. Although generally described as being selectively coupled together, it is envisioned that the laminated acoustic baffles of the acoustic baffle assembly 200 may be fixedly coupled together or combinations thereof. In embodiments, the laminated acoustic baffles may be coupled together, for example, using a friction fit, a press fit, interlocking features (e.g., mechanical features, such as detents, latches, etc.), mechanical fasteners, adhesives, and welding (e.g., ultrasonic welding, friction welding, etc.).With reference to FIGS. 17-19, a first laminated acoustic baffle 210A is illustrated. The first laminated acoustic baffle 210A is substantially similar to the laminated acoustic baffle 10 except that the first laminated acoustic baffle 210A does not include a support structure 50. Although generally illustrated as having two slots 226A formed through the top surface 222A and two slots 226A formed through the bottom surface 242A, it is envisioned that the first laminated acoustic baffle 210A may include any number of slots 226A formed at any position on the first laminated acoustic baffle 210A. As can be appreciated, the slots 226A of the first laminated acoustic baffle 210A are configured to interlock with corresponding slots of one or more of the laminated acoustic baffle 10, another first laminated acoustic baffle 210A, a second laminated acoustic baffle 210B, and/or a third laminated acoustic baffle 210C to form the acoustic baffle assembly 200.

Turning to FIGS. 20-22, a second laminated acoustic baffle 210B is illustrated. The second laminated acoustic baffle 210B is substantially similar to the first laminated acoustic baffle 210A, except that the second laminated acoustic baffle 210B does not include slots formed through the top surface 222B. In the example embodiment, the second laminated acoustic baffle includes four slots 226B formed through the bottom surface 242B.

With reference to FIGS. 23-25, a third laminated acoustic baffle 210C is illustrated. The third laminated acoustic baffle 210C is substantially similar to the first laminated acoustic baffle 210A, except that the third laminated acoustic baffle 210C includes a different profile formed on the bottom surface 242C than the profile formed on the bottom surface 242A of the first laminated acoustic baffle 210A. In the example embodiment, the third laminated acoustic baffle includes two slots 226C formed through the top surface 222C and two slots 226C formed through the bottom surface 242C.

With reference to FIG. 26, and exploded view representative of each of the first laminated acoustic baffle 210A, the second laminated acoustic baffle 210B, and the third laminated acoustic baffle 210C is illustrated. The first and second facings 290A, 300A are coupled to the first laminated acoustic baffle 210A, the second laminated acoustic baffle 210B, and the third laminated acoustic baffle 210C in a substantially similar manner to the first and second facings 90, 100 of the laminated acoustic baffle 10 described hereinabove, and therefore, will not be described herein in the interest of brevity.

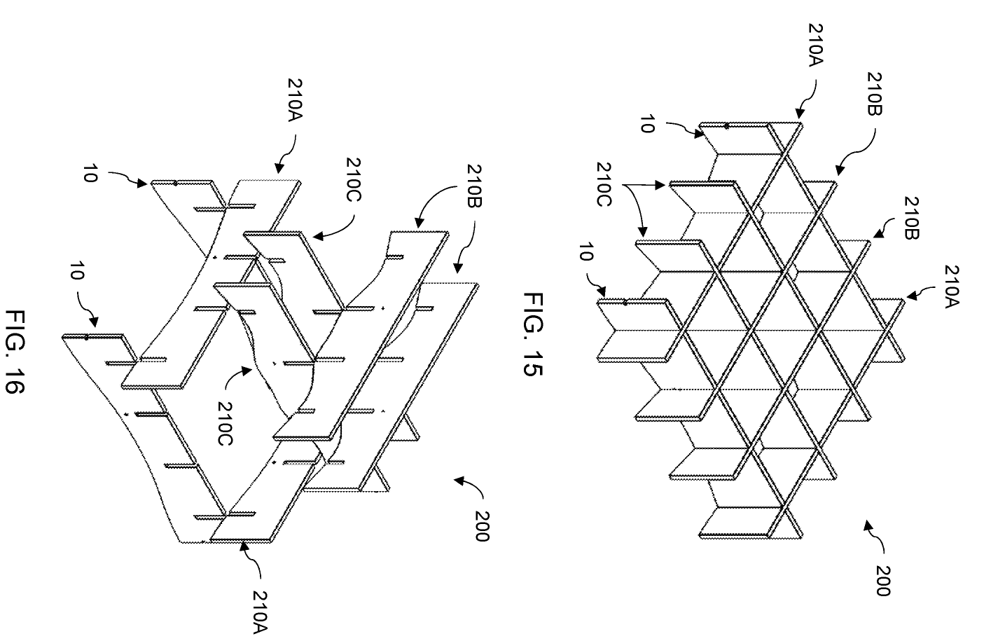

Returning to FIGS. 15 and 16, a method of assembling the acoustic baffle assembly 200 is illustrated. The method of assembling the acoustic baffle 200 assembly includes placing a pair of laminated acoustic baffles 10 in spaced relation to, and parallel with, one another. A pair of first laminated acoustic baffles 210A is oriented transverse to the pair of laminated acoustic baffles 10 to align slots 226A adjacent to the first and second end portions 218A, 220A of each of the pair of first laminated acoustic baffles 210A with respective slots 26 adjacent to the first and second end portions 18, 20 of each of the pair of laminated acoustic baffles 10. At this point, the pair of first laminated acoustic baffles 210A is advanced towards the pair of laminated acoustic baffles 10 to interlock the pair of first laminated acoustic panels 210A with the pair of laminated acoustic baffles 10. In this manner, a generally square or rectangular shape is formed with the pair of laminated acoustic baffles 10 and the pair of first laminated acoustic baffles 210A forming a perimeter. Next, a pair of third laminated acoustic baffles 210C is oriented transverse to the pair of first laminated acoustic baffles 210A to align slots 226C adjacent to the first and second end portions 218C, 220C of each of the pair of third laminated acoustic baffles 210C with respective slots 226A disposed at an interior portion of each of the pair of first laminated acoustic baffles 210A. The pair of third laminated acoustic baffles 210C is advanced towards the pair of first laminated acoustic baffles 210A to interlock the pair of third laminated acoustic baffles 210C with the pair of first laminated acoustic baffles 210A. With the pair of third laminated acoustic baffles 210C coupled to the pair of first laminated acoustic baffles 210A, a pair of second laminated acoustic baffles 210B is oriented transverse to the pair of third laminated acoustic baffles 210C to align slots 226B adjacent to the first and second end portions 218B, 220B of each of the pair of second laminated acoustic baffles 210B with respective slots 26 disposed at an interior portion of the pair of laminated acoustic baffles 10, and slots 226B, 226C disposed at an interior portion of both the pair of third laminated acoustic baffles 210C and the second laminated acoustic baffles 210B. At this point, the pair of second laminated acoustic baffles 210B is advanced towards the pair of laminated acoustic baffles 10 and the pair of third laminated acoustic baffles 210C to interlock or otherwise couple the pair of second laminated acoustic baffles 210B to each of the pair of third laminated acoustic baffles 210C and the pair of laminated acoustic baffles 10 to form the acoustic baffle assembly 200. The acoustic baffle assembly 200 may be coupled to adjacent acoustic baffle assemblies 200 via the support structures 50 of the laminated acoustic baffles 10 and/or the support structure 50 may be coupled to one or more hanging, suspending, and/or fixing elements to support the acoustic baffle assembly 200 at the desired location within the target environment.

Although generally described as being suspended or otherwise hung from a ceiling of an environment and/or building, the disclosure is not so limited. Any or all of the acoustic baffle assemblies and/or the laminated acoustic baffles may be coupled to or supported on or by any suitable structure, such as a wall, a combination of a wall and a ceiling, temporary structures, or may be used to form a wall or temporary structure. In some embodiments, the acoustic baffle assemblies and/or the laminated acoustic baffles may be rotatably supported by the support structure, enabling the acoustic baffle assemblies and/or the laminated acoustic baffles to rotate about a longitudinal axis formed by the support structure, or in a hemispherical range of motion about the fasteners and/or brackets coupled to the support structure.

Although the embodiments and examples disclosed herein have been described with reference to particular embodiments, it is to be understood that these embodiments and examples are merely illustrative of the principles and applications of the present disclosure. It is therefore to be understood that numerous modifications can be made to the illustrative embodiments and examples and that other arrangements can be devised without departing from the spirit and scope of the present disclosure as defined by the claims. Thus, it is intended that the present application cover the modifications and variations of these embodiments and their equivalents.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A laminated acoustic baffle, comprising:
a first panel defining a front surface and an opposite, back surface, each extending between opposing top and bottom surfaces and opposing first and second end portions;
a second panel defining a front surface and an opposite, back surface, each extending between opposing top and bottom surfaces and opposing first and second end portions;
a support structure interposed between the bottom surface of the first panel and the top surface of the second panel, wherein the support structure extends between a first end portion and an opposite, second end portion;
a first facing operably coupled to each of the front surface of the first panel and the front surface of the second panel; and
a second facing operably coupled to each of the back surface of the first panel and the back surface of the second panel,
wherein each of the first end portion and the second end portion of the support structure is exposed from each of the first panel, the second panel, the first facing, and the second facing.

2. The laminated acoustic baffle according to claim 1, wherein the support structure is operably coupled to each of the bottom surface of the first panel and the top surface of the second panel.

3. The laminated acoustic baffle according to claim 1, wherein the support structure is operably coupled to each of the first facing and the second facing.

4. The laminated acoustic baffle according to claim 1, wherein the support structure is frictionally engaged with at least one of the first panel and the second panel to inhibit movement of the support structure relative to the first panel and the second panel.

5. The laminated acoustic baffle according to claim 1, wherein the support structure is frictionally engaged with at least one of the first facing and the second facing to inhibit movement of the support structure relative to one or more of the first panel, the second panel, the first facing, and the second facing.

6. The laminated acoustic baffle according to claim 1, wherein the support structure defines at least one radially extending leg, wherein the at least one radially extending leg engages at least a portion of one of the first panel and the second panel.

7. The laminated acoustic baffle according to claim 1, wherein the support structure defines a first radially extending leg and a second radially extending leg, wherein the first radially extending leg engages at least a portion of the first panel and the second radially extending leg engages at least a portion of the second panel.

8. The laminated acoustic baffle according to claim 1, wherein the support structure is rotatably couplable to at least one support member to rotatably support the first panel, the second panel, the first facing, and the second facing about a longitudinal axis defined through each of the first end portion and the second end portion of the support structure.

9. The laminated acoustic baffle according to claim 1, wherein one or more slots are defined through the top surface of the first panel, the front surface of the first panel, the back surface of the first panel, and each of the first facing and the second facing, wherein the one or more slots are configured to selectively engage a second laminated acoustic baffle.

10. The laminated acoustic baffle according to claim 1, wherein a width of the support structure is less than a width of each of the first panel and the second panel, wherein a first gap is defined between the first facing and the support structure and a second gap is defined between the second facing and the support structure.

11. An acoustic baffle assembly, comprising:
at least two laminated acoustic baffles, wherein a first laminated acoustic baffle of the at least two laminated acoustic baffles is selectively interlockable with a second laminated acoustic baffle of the at least two laminated acoustic baffles, wherein each of the first laminated acoustic baffle and the second laminated acoustic baffle comprises:
a first panel;
a second panel;
a support structure interposed between the first panel and the second panel, the support structure extending between a first end portion and an opposite, second end portion;
a first facing operably coupled to a first side of each of the first panel and the second panel; and
a second facing operably coupled to a second, opposite side of each of the first panel and the second panel,
wherein each of the first end portion and the second end portion of the support structure is exposed from each of the first panel, the second panel, the first facing, and the second facing.

12. The acoustic baffle assembly according to claim 11, further comprising a third laminated acoustic baffle, the third laminated acoustic baffle comprising:
a first panel;
a second panel;
a support structure interposed between the first panel and the second panel, the support structure extending between a first end portion and an opposite, second end portion;
a first facing operably coupled to a first side of each of the first panel and the second panel; and
a second facing operably coupled to a second, opposite side of each of the first panel and the second panel,
wherein at least one of the first end portion and the second end portion of the support structure is exposed from each of the first panel, the second panel, the first facing, and the second facing.

13. The acoustic baffle assembly according to claim 12, wherein the first end portion of the support structure of one of the first laminated acoustic baffle and the second laminated acoustic baffle is operably coupled to the exposed one of the first end portion and the second end portion of the third laminated acoustic baffle.

14. The acoustic baffle assembly according to claim 12, wherein the first end portion of the support structure of one of the first laminated acoustic baffle and the second laminated acoustic baffle defines a pivot point, wherein at least one of the first laminated acoustic baffle and the second laminated acoustic baffle is rotatable about the pivot point.

15. The acoustic baffle assembly according to claim 11, wherein the first laminated acoustic baffle further comprises a first slot defined through a top surface of the first panel and the second laminated acoustic baffle further comprises a second slot defined through a bottom surface of the second panel, wherein the first slot of the first laminated acoustic baffle interlocks with the second slot of the second laminated acoustic baffle to couple the first laminated acoustic baffle to the second laminated acoustic baffle.

16. The acoustic baffle assembly according to claim 11, wherein the support structure of the first laminated acoustic baffle is frictionally engaged with one or more of the first panel, the second panel, the first facing, and the second facing to inhibit movement of the support structure relative to the first panel, the second panel, the first facing, and the second facing.

17. The acoustic baffle assembly according to claim 11, wherein the support structure of the first laminated acoustic baffle defines at least one radially extending leg, wherein the at least one radially extending leg engages at least a portion of one of the first panel and the second panel of the first laminated acoustic baffle.

18. The acoustic baffle assembly according to claim 11, wherein the exposed one of the first end portion and the second end portion of the support structure of the first laminated acoustic baffle and the second laminated acoustic baffle is selectively couplable to a support member to support the interlocked first and second laminated acoustic panels.

19. The acoustic baffle assembly according to claim 18, wherein a threaded bore is defined through the exposed one of the first end portion and the second end portion of the support structure of the first laminated acoustic baffle and the second laminated acoustic baffle, wherein the threaded bore is threadably engageable with a fastener to support the interlocked first and second laminated acoustic baffles.

20. The acoustic baffle assembly according to claim 11, wherein the first facing of each of the first laminated acoustic baffle and the second laminated acoustic baffle is adhered to a first side of each of the first panel and the second panel and the second facing of each of the first laminated acoustic baffle and the second laminated acoustic baffle is adhered to an opposite, second side of each of the first panel and the second panel, wherein the support structure of each of the first laminated acoustic baffle and the second laminated acoustic baffle is frictionally engaged with one or more of the first panel, the second panel, the first facing, and the second facing of a respective first laminated acoustic baffle and second laminated acoustic baffle.
